(19) United States
(12) Patent Application Publication
(10) Pub. No.: US 2014/0164131 A1
(43) Pub. Date: Jun. 12, 2014

(54) APPARATUS AND METHOD FOR PROVIDING DIGITAL SIGNAGE RELATED TO MOBILE TERMINAL

(71) Applicant: Electronics and Telecommunications Research Institute, Daejeon (KR)

(72) Inventors: Eun-Il KIM, Seoul (KR); Hyun-Jin LEE, Daejeon (KR)

(73) Assignee: Electronics and Telecommunications Research Institute, Daejeon (KR)

(21) Appl. No.: 13/948,058

(22) Filed: Jul. 22, 2013

(30) Foreign Application Priority Data
Dec. 12, 2012 (KR) 10-2012-0144637

(51) Int. Cl. G06Q 30/02

(52) U.S. Cl. CPC G06Q 30/0267
USPC 705/14.61

(57) ABSTRACT

Provided is a method of providing content in a digital signage providing device in association with a mobile terminal, the method including generating content to be played in a digital signage terminal and a schedule indicating a time at which the content is to be played, converting the generated content into content for the mobile terminal to additionally generate the content, transmitting, to the digital signage terminal, the generated content together with the schedule, requesting the digital signage terminal to transmit content that is being played to the mobile terminal, according to a request from the mobile terminal, and transmitting, to the mobile terminal, a mobile terminal version of the requested content in a multicast manner.

### CROSS-REFERENCE TO RELATED APPLICATION

This application claims priority from Korean Patent Application No. 10-2012-0144637, filed on Dec. 12, 2012, in the Korean Intellectual Property Office, the entire disclosure of which is incorporated herein by reference for all purposes.

### BACKGROUND

1. Field

The following description relates to digital signage technology, and more particularly, to a device and method for sharing content between a digital signage terminal and a mobile terminal.

2. Description of the Related Art

Digital signage technology is used to digitally express an outdoor sign for an established advertisement through digital image equipment. A device using the digital signage technology generally combines a display with an outdoor advertisement to provide text, image, or video content.

A conventional digital signage providing device focuses more on a service of digital signage itself than on content transmission to a mobile device. Therefore, according to the related art, installation, operation, and replacement of content are performed in digital signage itself in order to provide content.

However, with the development of communication networks, digital signage control has been recently performed remotely via a network. Interaction with a user also has been enhanced so as to provide a customized digital signage service suitable for an attribute of the user or circumstances.

Therefore, content is frequently transmitted through interaction between a digital signage terminal and a mobile terminal of the user. However, since content is transmitted to mobile devices of a plurality of users in a wireless network environment with limited resources, a shortage in bandwidth occurs. This bandwidth shortage may hinder normal provision of a content providing service.

### SUMMARY

The present invention provides a device and method for sharing and playing content played in a digital signage terminal in a mobile terminal of a user.

The present invention provides a device and method for providing digital signage content to a plurality of mobile terminals in a wireless network environment having limited resources.

The present invention provides a device and method for providing digital signage content to a plurality of mobile terminals in a multicast manner.

The present invention provides a device and method for generating content for a mobile terminal by converting content for a digital signage terminal to provide the generated content to a plurality of mobile terminals.

In one general aspect, a method of providing content in a digital signage providing device in association with a mobile terminal includes generating content to be played in a digital signage terminal and a schedule indicating a time at which the content is to be played, converting the generated content into content for the mobile terminal to additionally generate the content, transmitting, to the digital signage terminal, the generated content together with the schedule, requesting the digital signage terminal to transmit content that is being played to the mobile terminal, according to a request from the mobile terminal, and transmitting, to the mobile terminal, a mobile terminal version of the requested content in a multicast manner.

In one general aspect, a method of providing content in a digital signage terminal in association with a mobile terminal includes receiving, from a digital signage providing device, content and a schedule indicating a time at which the content is to be played, playing the content according to the schedule, and transmitting, to the mobile terminal, the content that is being played according to a request for transmitting the content that is being played from the digital signage providing device.

In one general aspect, a method of receiving digital signage content in a mobile terminal includes requesting content provided in a digital signage terminal from a digital signage providing device, and receiving the content from the digital signage terminal.

In one general aspect, a digital signage providing device includes a content generation unit configured to generate content to be played in a digital signage terminal and a schedule indicating a time at which the content is to be played, a content provision unit configured to receive the content generated by the content generation unit and transmit the content to the digital signage terminal, a schedule management unit configured to transmit the schedule generated by the content generation unit to the digital signage terminal, and a mobile terminal association unit configured to control the content that is being played in the digital signage terminal so as to transmit the content to a mobile terminal according to a request from the mobile terminal.

Other features and aspects will be apparent from the following detailed description, the drawings, and the claims.

### BRIEF DESCRIPTION OF THE DRAWINGS

FIG. 1 is a block diagram illustrating a system including a digital signage providing device according to an embodiment of the present invention;

FIG. 2 is a flowchart illustrating a method of providing digital signage in association with a mobile terminal;

FIG. 3 is a flowchart illustrating a method of generating content and a schedule according to an embodiment of the present invention;

FIG. 4 is a flowchart illustrating an operation of transmitting generated content to the digital signage terminal together with the schedule;

FIG. 5 is a flowchart illustrating a login operation of a mobile terminal according to an embodiment of the present invention; and

FIG. 6 is a flowchart illustrating an operation of multicasting content to a mobile terminal according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, preferred embodiments of the present invention will be described in detail with reference to the accompanying drawings.

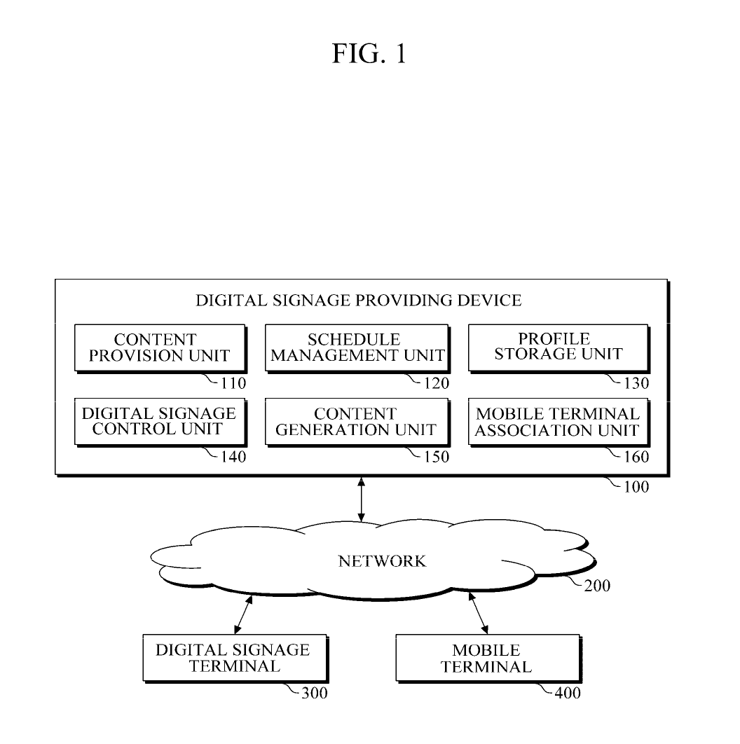

FIG. 1 is a block diagram illustrating a system including a digital signage providing device according to an embodiment of the present invention.

Referring to FIG. 1, a digital signage providing device 100 is connected to a digital signage terminal 300 via a network 200 to provide content to the digital signage terminal 300 and enable content reproduced in the digital signage terminal 300 to be shared with a mobile terminal 400.

Here, for the network 200, wireless LAN (WLAN), Wi-Fi, wireless broadband (Wibro), world interoperability for microwave access (Wimax), high-speed downlink packet access (HSDPA), etc. may be used.

The signage terminal 300, which is a digital image device for displaying an image or information by means of a flat display or a projector using digital technology, is a communication tool used by corporations for marketing, advertising, training, and enhancing customer experience, and may provide not only a broadcast program but also specific information in a public place such as an airport, a hotel, or a hospital.

The mobile terminal 400 may include a terminal provided with a memory and a microprocessor to have calculation capability, such as a smartphone, a notebook computer, a digital broadcasting terminal, a personal digital assistant (PDA), a portable multimedia player (PMP), or a navigator (vehicle navigation device).

More specifically, the digital signage providing device 100 includes a content provision unit 110, a schedule management unit 120, a profile storage unit 130, a digital signage control unit 140, a content generation unit 150, and a mobile terminal association unit 160. Although FIG. 1 illustrates that these elements are included in a single device, this configuration is just an example and the present invention is not limited thereto. That is, the content provision unit 110, the schedule management unit 120, the profile storage unit 130, the digital signage control unit 140, the content generation unit 150, and the mobile terminal association unit 160 may be configured with separate server devices.

The content provision unit 110 transmits, to the digital signage terminal 300, content generated by the content generation unit 150. In detail, the content provision unit 110 transfers, to the digital signage terminal 300, a link that provides location information on content and a schedule, and, in response to a content request from the digital signage terminal 300, transmits, to the digital signage terminal 300, content for a digital signage terminal and pre-converted content for a mobile terminal related to the requested content. Here, the schedule is information that indicates a time at which at least one piece of content is to be played.

The schedule management unit 120 transmits, to the digital signage terminal 300, a schedule generated by the content generation unit 150.

The profile storage unit 130 stores profile information including authentication information on an ID of a user connected through the content generation unit 150 or the mobile terminal 400. For example, corresponding to the ID assigned to the user, information such as a password for login, a name, an age, an educational background, a job, contact information (a mobile phone number or wire phone number), etc. may be stored. Further, information on interests and preferences of the user may be included.

The digital signage control unit 140 searches the profile storage unit 130 to perform user authentication, in response to a login request from the user desiring to generate content through the content generation unit 150. The digital signage control unit 140 checks an upload authority to permit upload, in response to a request for upload of the content and schedule generated from the content generation unit 150.

The content generation unit 150 generates content to be played in the digital signage terminal 300 and a schedule indicating a time at which the content is to be played, and uploads the content and the schedule to the content provision unit 110 and the schedule management unit 120 respectively. Here, the content and the schedule may be generated according to a value input by the logged-in user. That is, the content generation unit 150 is an interface for receiving content and schedule generation information from the user, and may be configured with a terminal such as a separate computer.

In response to a request from the mobile terminal 400, the mobile terminal association unit 160 controls content played in the digital signage terminal 300 so as to transmit the content to the mobile terminal 400. The mobile terminal association unit 160 also performs login authentication of the mobile terminal 400.

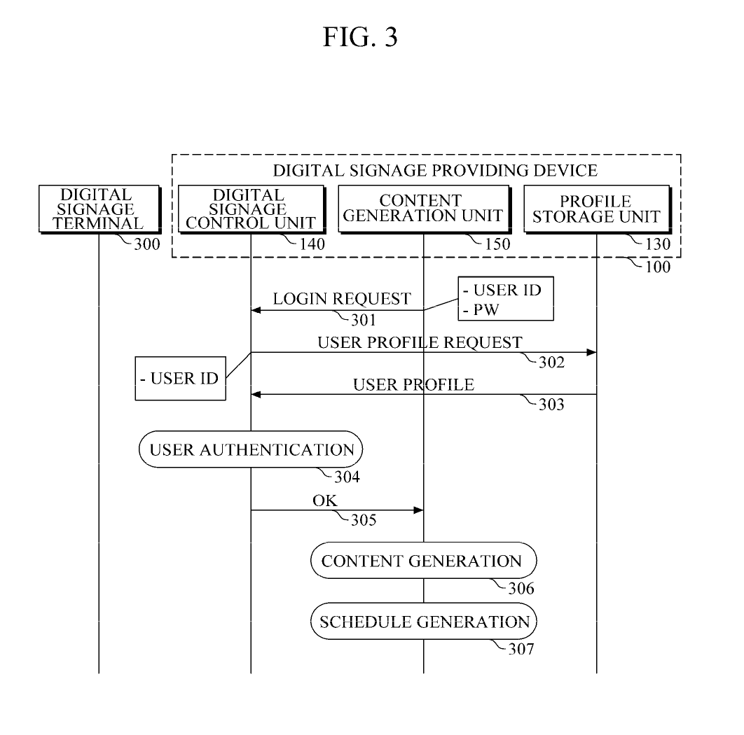

Operations of the above-described elements of the system will be described in more detail with reference to FIGS. 3 to 6.

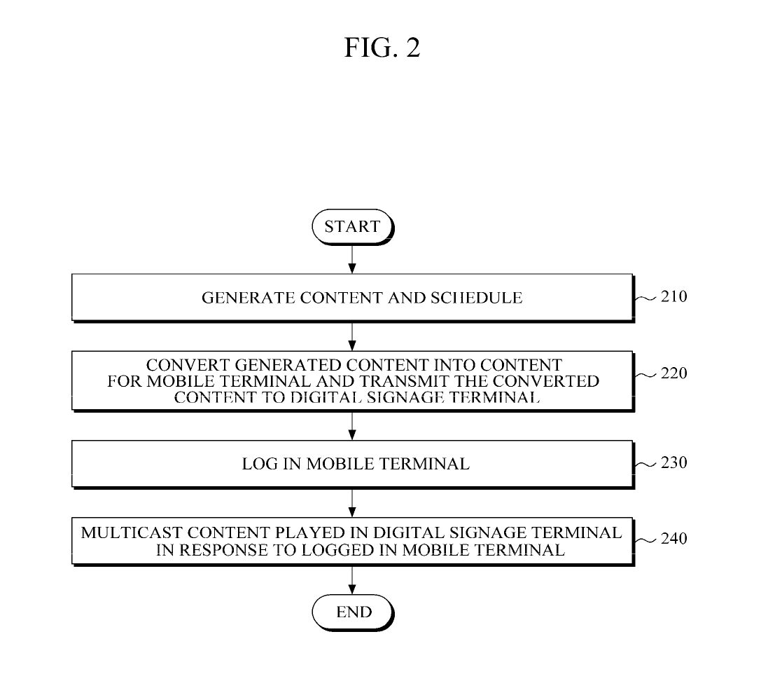

FIG. 2 is a flowchart illustrating a method of providing mobile terminal-associated digital signage according to an embodiment of the present invention.

Referring to FIG. 2, the method of providing mobile terminal-associated digital signage includes: generating content to be played in a digital signage terminal and a schedule indicating a time at which the content is to be played (operation 210); transmitting, to the digital signage terminal, the generated content and converted content for a mobile terminal together with the schedule (operation 220); logging in a mobile terminal desiring to receive content played in the digital signage terminal (operation 230); and multicasting the content played in the digital signage terminal to the mobile terminal in response to a request from the logged in mobile terminal (operation 240). These operations will be described in detail with reference to FIGS. 3 to 6.

FIG. 3 is a flowchart illustrating an operation of generating content and a schedule according to an embodiment of the present invention.

Referring to FIG. 3, in order to generate the content and the schedule, the user requests login from the digital signage control unit 140 via the content generation unit 150 (operation 301). Here, a user ID and a password are input.

The digital signage control unit 140 requests a user profile corresponding to the user ID and the password from the profile storage unit 130 (operation 302). Then, the profile storage unit 130 searches for the user profile corresponding to the user ID and the password and transfers the user profile to the digital signage control unit 140 (operation 303).

The digital signage control unit 140 performs user authentication by comparing the user profile with information received when login is requested (operation 304). Then, a result of the user authentication is reported to the content generation unit 150 (operation 305). The content generation unit 150 generates content to be used for digital signage (operation 306), and generates a schedule indicating a time at which the content is to be played (operation 307).

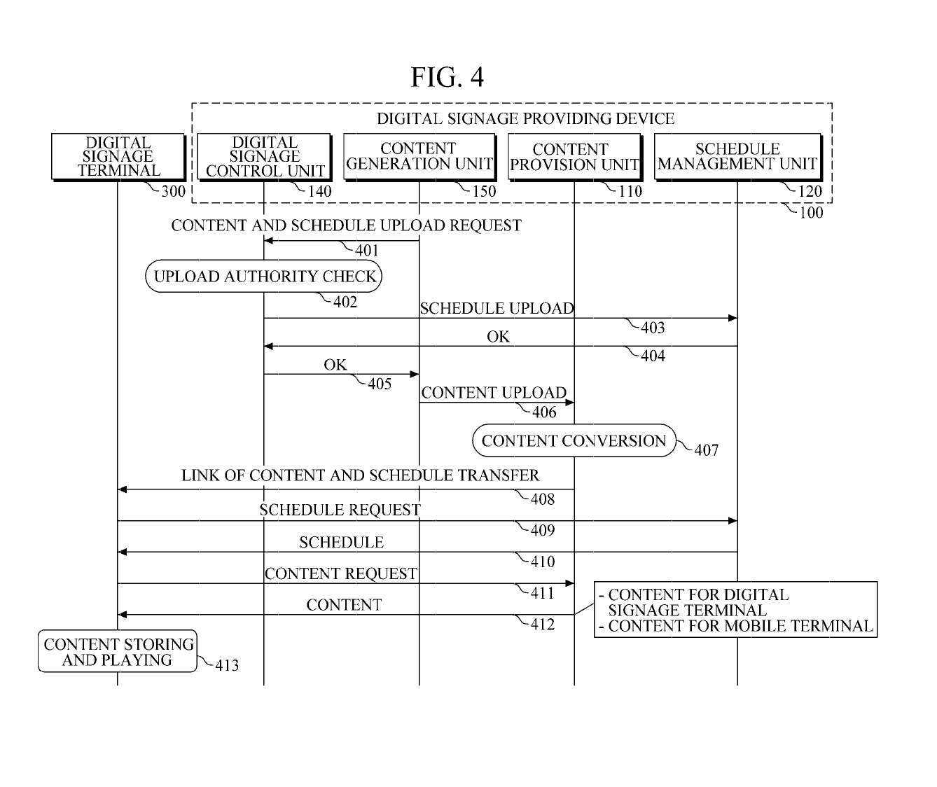

FIG. 4 is a flowchart illustrating an operation of transmitting generated content to the digital signage terminal together with the schedule according to an embodiment of the present invention.

Referring to FIG. 4, a request message for uploading the content and the schedule generated by the content generation unit 150 to the content provision unit 110 is transmitted to the digital signage control unit 140 (operation 401).

The digital signage control unit 140 checks the upload authority of the user (operation 402), and uploads the schedule to the schedule management unit 120 when the user has the upload authority (operation 403). After the schedule is uploaded, the schedule management unit 120 transmits an acknowledgement message (OK) to the digital signage control unit 140 (operation 404). When the schedule upload is confirmed, the digital signage control unit 140 transmits a content upload permission message to the content generation unit 150 (operation 405).

The content generation unit 150 uploads the generated content to the content provision unit 110 (operation 406). For efficient content sharing with a mobile terminal, the content provision unit 110 generates content for a mobile terminal by converting the uploaded content (operation 407). The content provision unit 110 transmits, to the digital signage terminal 300, a link that provides location information on the content and schedule (operation 408).

The digital signage terminal 300 requests the schedule from the schedule management unit 120 by using the received link (operation 409). In response to this request, the schedule management unit 120 transmits the schedule to the digital signage terminal 300 (operation 410).

Then, the digital signage terminal 300 requests the content from the content provision unit 110 by using the content link (operation 411). The content provision unit 110 transmits, to the digital signage terminal 300, the content for a digital signage terminal and the pre-converted content for a mobile terminal related to the requested content (operation 412).

The digital signage terminal 300 that has received the content stores the content and plays the content for a digital signage terminal according to the schedule (operation 413).

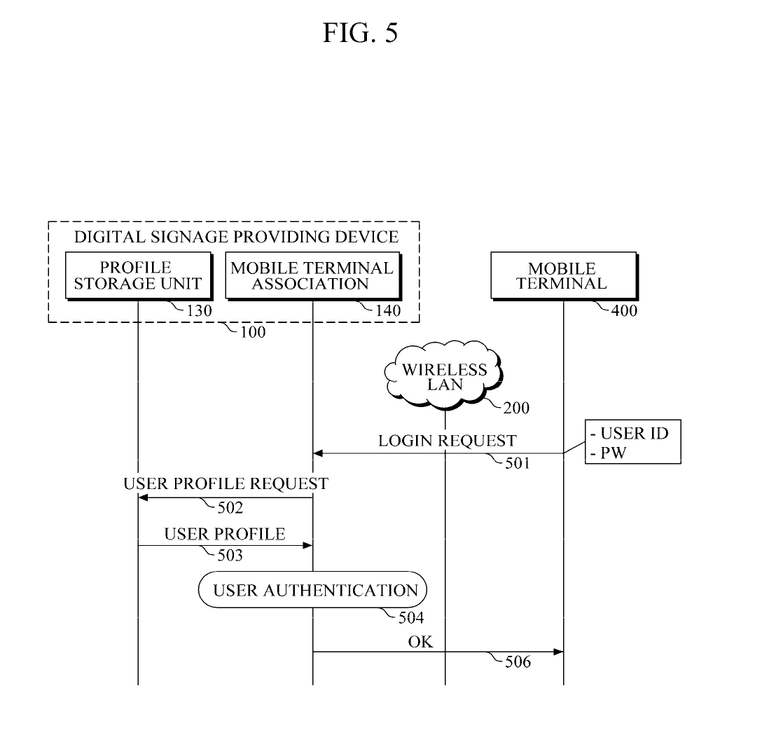

FIG. 5 is a flowchart illustrating a login operation of a mobile terminal according to an embodiment of the present invention.

Referring to FIG. 5, while viewing the content played in the digital signage terminal 300, the user makes a request for login to the mobile terminal association unit 160 from the mobile terminal 400 in order to use a digital signage service (operation 501).

The mobile terminal association unit 160 requests user profile information from the profile storage unit 130 (operation 502). The profile storage unit 130 transmits the user profile information to the mobile terminal association unit 160.

The mobile terminal association unit 160 performs user authentication by comparing the user profile information with the information received when the login is requested (operation 504), and transmits a result of the authentication to the mobile terminal 400 (operations 505).

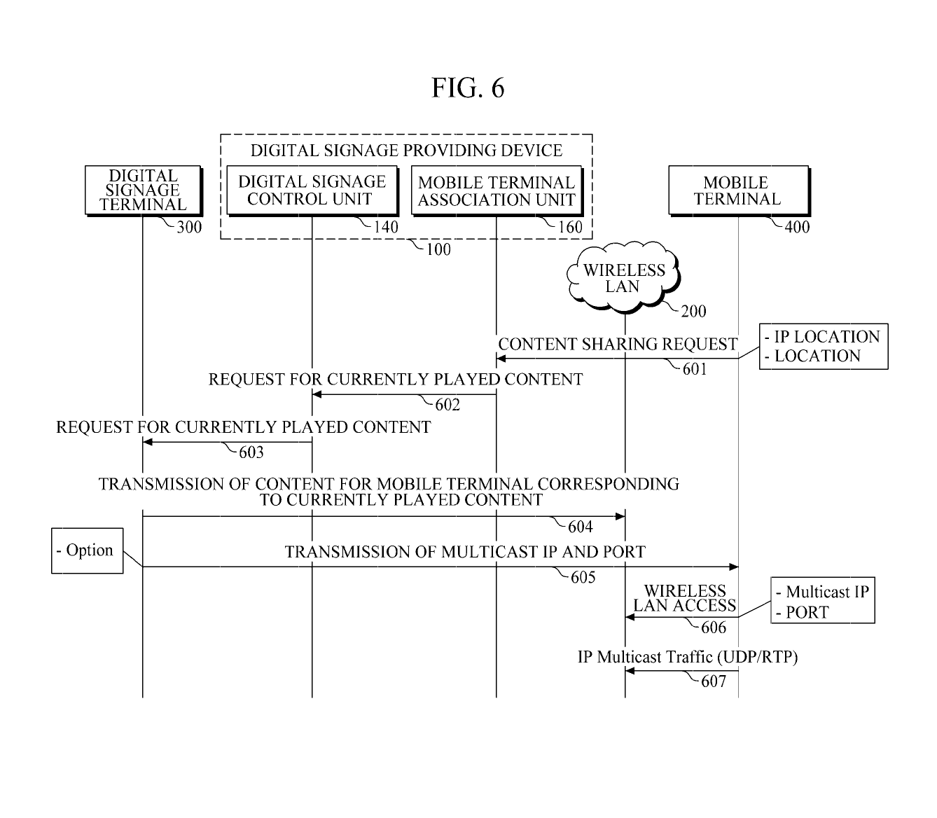

FIG. 6 is a flowchart illustrating an operation of multicasting content to a mobile terminal according to an embodiment of the present invention.

Referring to FIG. 6, the mobile terminal 400 that has successfully logged in requests the content played in the digital signage terminal 300 from the mobile terminal association unit 160 (operation 601). The mobile terminal association unit 160 requests the played content from the digital signage control unit 140 (operation 602), and the digital signage control unit 140 transfers, to the digital signage terminal 300, a message indicating that the played content is requested by the mobile terminal (operation 603).

The digital signage terminal 300 transmits, to the wireless network 200, mobile content of played content in a multicast manner (operation 604). Thereafter, a multicast IP and port information are transmitted to the mobile terminal 400 so that the mobile terminal 400 receives the content in the multicast manner (operation 605). However, although not illustrated in the drawings, the digital signage terminal 300 checks whether the transmission-requested content has been multicast according to a request from another mobile terminal. In the case where the checking determines that the content has already been multicast, operation 604 may be omitted and only the multicast IP and the port information may be transmitted to the mobile terminal.

The mobile terminal 400 accesses the wireless LAN using the multicast IP and the port information in order to download content (operation 606), and receives the content transmitted to the wireless network 200 by the digital signage terminal 300 (operation 607).

According to the present invention, the content played in the digital signage terminal may also be shared and played by the mobile terminal of the user. Further, for more efficient content sharing between the digital signage terminal and the mobile terminal, content for a digital signage terminal having a relatively large volume is converted into content for a mobile terminal which is optimized for a mobile terminal, and the content for a mobile terminal is stored. When the mobile terminal requests content, the content for a mobile terminal having a relatively small volume is transmitted, and thus unnecessary consumption of limited network resources may be prevented in an environment where communication with a plurality of mobile terminals is performed.

In addition, according to the prior art, content is transmitted to a mobile terminal in a unicast manner, and thus a lot of bandwidth is consumed when the content is transmitted to a plurality of mobile terminals. To overcome this limitation, the digital signage terminal serves as a multicast server to transmit content to a mobile terminal in a multicast manner, thereby using minimal bandwidth. Therefore, content may be efficiently shared with a plurality of mobile terminals. Utilizing this aspect, urgent content requiring real-time transmission, such as a disaster broadcast, may be transmitted to the digital signage terminal and a plurality of mobile terminals adjacent thereto.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing content in a digital signage providing device in association with a mobile terminal, the method comprising:
generating content to be played in a digital signage terminal and a schedule indicating a time at which the content is to be played;
transmitting, to the digital signage terminal, the generated content together with the schedule; and
requesting the digital signage terminal to transmit content that is being played to the mobile terminal, according to a request from the mobile terminal.

2. The method of claim 1, wherein the generating comprises generating the content and the schedule according to information input from a logged-in user.

3. The method of claim 1, further comprising:
converting the content into content for the mobile terminal,
wherein the transmitting comprises transmitting content to be played in the digital signage terminal and the converted content for the mobile terminal.

4. The method of claim 1, wherein the transmitting comprises:
delivering, to the digital signage terminal, a link providing location information on the content and the schedule;
delivering the content according to a request from the digital signage terminal that has referred to the link; and
delivering the schedule of the content according to the request from the digital signage terminal that has referred to the link.

5. A method of providing content in a digital signage terminal in association with a mobile terminal, the method comprising:
receiving, from a digital signage providing device, content and a schedule indicating a time at which the content is to be played;
playing the content according to the schedule; and
transmitting, to the mobile terminal, the content that is being played according to a request for transmitting the content that is being played from the digital signage providing device.

6. The method of claim 5, wherein the receiving comprises receiving content for the mobile terminal together with content for the digital signage terminal.

7. The method of claim 6, further comprising:
storing the content for the mobile terminal.

8. The method of claim 5, wherein the receiving comprises:
receiving, from the digital signage providing device, a link providing location information on the content and the schedule;
requesting the schedule from the digital signage providing device by using the link;
receiving the requested schedule from the digital signage providing device;
requesting the content from the digital signage providing device by using the link; and
receiving the requested content from the digital signage providing device.

9. The method of claim 5, wherein the receiving comprises:
multicasting the content that is being played to a wireless LAN; and
transmitting a multicast IP and port information to the mobile terminal.

10. The method of claim 9, wherein the transmitting comprises:
checking whether the transmission-requested content has been multicast according to a request from another mobile terminal; and
transmitting only the multicast IP and the port information in the case where the transmission-requested content has been multicast.

11. A method of receiving digital signage content in a mobile terminal, the method comprising:
requesting content provided in a digital signage terminal from a digital signage providing device; and
receiving the content from the digital signage terminal.

12. The method of claim 11, wherein the receiving comprises:
receiving a multicast IP and port information from the digital signage terminal;
accessing a wireless LAN by using the received multicast IP and port information; and
receiving, from the wireless LAN, the content transmitted from the digital signage terminal.

13. A digital signage providing device comprising:
a content generation unit configured to generate content to be played in a digital signage terminal and a schedule indicating a time at which the content is to be played;
a content provision unit configured to receive the content generated by the content generation unit and transmit the content to the digital signage terminal;
a schedule management unit configured to transmit the schedule generated by the content generation unit to the digital signage terminal; and
a mobile terminal association unit configured to control the content that is being played in the digital signage terminal so as to transmit the content to a mobile terminal according to a request from the mobile terminal.

14. The digital signage providing device of claim 13, wherein the content provision unit converts the generated content into content for the mobile terminal, and transmits content to be played in the digital signage terminal and the converted content for the mobile terminal.

15. The digital signage providing device of claim 13, further comprising:
a profile storage unit and a digital signage control unit,
wherein the profile storage is searched to perform user authentication, according to a login request from the content generation unit.

16. The digital signage providing device of claim 13, wherein the content provision unit transfers, to the digital signage terminal, a link providing location information on the content and the schedule, and, according to a content request from the digital signage terminal, transmits, to the digital signage terminal, content for the digital signage terminal and pre-converted content for the mobile terminal related to the requested content.

17. The digital signage providing device of claim 13, further comprising:
a profile storage unit,
wherein the mobile terminal association unit performs mobile terminal login authentication so that a user viewing content that is being played in the digital signage terminal uses a digital signage service.

18. The digital signage providing device of claim 15, wherein the digital signage control unit checks upload authority according to a request for uploading the generated content and schedule so as to allow the content and the schedule to be uploaded to the content provision unit and the schedule management unit respectively.
